(19) United States
(12) Patent Application Publication
(10) Pub. No.: US 2025/0307974 A1
(43) Pub. Date: Oct. 2, 2025

(54) DIFFUSION WATERMARKING FOR CAUSAL ATTRIBUTION

(71) Applicant: ADOBE INC., SAN JOSE, CA (US)

(72) Inventors: Shruti Agarwal, San Jose, CA (US); John Collomosse, London (GB); Vishal Asnani, East Lansing, MI (US)

(21) Appl. No.: 18/617,969

(22) Filed: Mar. 27, 2024

(51) Int. Cl. G06T 1/00; G06T 11/60

(52) U.S. Cl. CPC G06T 1/0021; G06T 11/60

(57) ABSTRACT

A method, apparatus, non-transitory computer readable medium, apparatus, and system for image processing include obtaining an input prompt describing an image element, generating, using an image generation model, an output image depicting the image element and including a watermark, and identifying the training image as a source of the output image based on the watermark. The image generation model is trained using a training image including the image element and the watermark.

### BACKGROUND

The following relates generally to image processing, and more specifically to image generation. Diffusion models have been used to create new images that resemble aspects of the training data. In some cases, the generated images retain concepts from the training data, such as objects, motifs, templates, artists, or styles. Watermarks may be used to trace and attribute the retained concepts back to the original sources within the training dataset.

Some methods for concept attribution in generative artificial intelligence (AI) rely on passive correlation. Passive correlation involves matching generated images to training data based on similarities including visual similarities. However, since correlation is different from causation, passive correlation-based methods can fall short in establishing a causal link between training data and synthesized images.

### SUMMARY

A method, apparatus, and non-transitory computer readable medium for image processing are described. One or more aspects of the method, apparatus, and non-transitory computer readable medium include obtaining an input prompt describing an image element, generating, using an image generation model, an output image depicting the image element and including a watermark, and identifying the training image as a source of the output image based on the watermark. The image generation model is trained using a training image including the image element and the watermark.

A method, apparatus, and non-transitory computer readable medium for image processing are described. One or more aspects of the method, apparatus, and non-transitory computer readable medium include creating a training set by adding a watermark to an image depicting an image element, and training, using the training set, an image generation model to generate an output image depicting the image element and including the watermark based on an input prompt describing the image element.

An apparatus and method for image processing are described. One or more aspects of the apparatus and method include at least one processor, at least one memory storing instruction executable by the at least one processor, and an image generation model comprising parameters stored in the at least one memory and trained generate an output image depicting an image element and including a watermark. The image generation model is trained using a training image including the image element and the watermark, and identify the training image as a source of the output image based on the watermark.

### BRIEF DESCRIPTION OF THE DRAWINGS

FIG. 1 shows an example of an image processing system according to aspects of the present disclosure.

FIG. 2 shows an example of an image generation process 200 according to aspects of the present disclosure.

FIG. 3 shows an example of an image generation process 300 according to aspects of the present disclosure.

FIG. 4 shows an example of a causative matching process according to aspects of the present disclosure.

FIG. 5 shows an example of a method for image processing according to aspects of the present disclosure.

FIG. 6 shows an example of an image processing apparatus according to aspects of the present disclosure.

FIG. 7 shows an example of a U-Net according to aspects of the present disclosure.

FIG. 8 shows an example of a diffusion process according to aspects of the present disclosure.

FIG. 9 shows an example of training and inference of an image generation model according to aspects of the present disclosure.

FIG. 10 shows an example of a method for training a machine learning model according to aspects of the present disclosure.

FIG. 11 shows an example of figure description according to aspects of the present disclosure.

### DETAILED DESCRIPTION

Diffusion models create new images that resemble aspects of the training data. The resemblance may be a result that the generated images retain some concepts in the training data, such as the objects, motifs, templates, artists, or styles of the training data. However, this resemblance may raise concerns about the recognition and compensation of original content creators whose works contribute to the training of generative AI models including diffusion models. Concept attribution is a task of tracing concepts retained in the generated image back to the original sources in the training data.

Some methods for causal attribution rely on passive correlation. However, passive correlation-based methods fall short in establishing a causal link between training data and synthesized images. Some methods embed watermarks to the training data to identify sources in the training data. However, these methods decrease the qualities of generated images and in some cases, the watermarks cannot be detected in the generated images.

Embodiments of the present disclosure provide a proactive approach to embed watermarks into training data, enabling a causative matching for concept attribution tasks. In one aspect, visually imperceptible watermarks are embedded in training images. In one aspect, the diffusion model is trained to retain the corresponding watermarks in the generated images. In some cases, a training image can include more than one watermark. This method increases the accuracy of concept attribution by utilizing corresponding watermarks embedded in the training data of diffusion models to link generated images to their originating concepts, thereby improving the traceability and accountability of the image generation process.

Embodiments of the present disclosure improve conventional image generation models by providing more accurate image attribution for generated images. By integrating identifiable watermarks into the training phase of a diffusion model, embodiments enable attribution for images related to specific training concepts. This provides a verifiable linkage between output visuals and the training origins, bolstering traceability and accountability of generative AI models.

In some cases, the generated images retain concepts from the training data, such as objects, motifs, templates, artists, or styles. Watermarks may be used to trace and attribute the retained concepts back to the original sources within the training dataset. In some cases, this attribution can be used to recognize and compensate content creators, facilitating the acknowledgement of content creators' creations when these creations are utilized in training datasets for AI models.

Some methods for concept attribution in generative AI rely on passive correlation. Passive correlation involves matching generated images to training data based on similarities including visual similarities. However, correlation is different from causation. Passive correlation-based methods fall short in establishing a causal link between training data and synthesized images.

### Image Processing Method

A method for image processing is described. One or more aspects of the method include obtaining an input prompt describing an image element and generating, using an image generation model, an output image depicting the image element and a watermark, wherein the image generation model is trained using a training set including a plurality of images having a plurality of watermarks corresponding to a plurality of training concepts, respectively, and wherein the watermark comprises one of the plurality of watermarks and indicates a concept of the plurality of training concepts corresponding to the image element.

In one aspect, generating the output image comprises generating, using a generator of the image generation model, a latent code representing the input prompt and the watermark and decoding, using a decoder of the image generation model, the latent code to obtain the output image. In one aspect, generating the latent code comprises performing a latent diffusion process. In one aspect, the decoder is fixed during a training stage in which the generator is trained using the training data.

Some examples of the method, apparatus, and non-transitory computer readable medium further include determining that the output image is attributable to a training image from the plurality of images in the training set. In one aspect, the watermark is located in a pre-determined region of the output image, wherein each of the plurality of watermarks corresponds to a plurality of pre-determined regions, respectively. In one aspect, the plurality of pre-determined regions are non-overlapping. Some examples of the method, apparatus, and non-transitory computer readable medium further include obtaining a noise input, wherein the output image is generated based on the noise input.

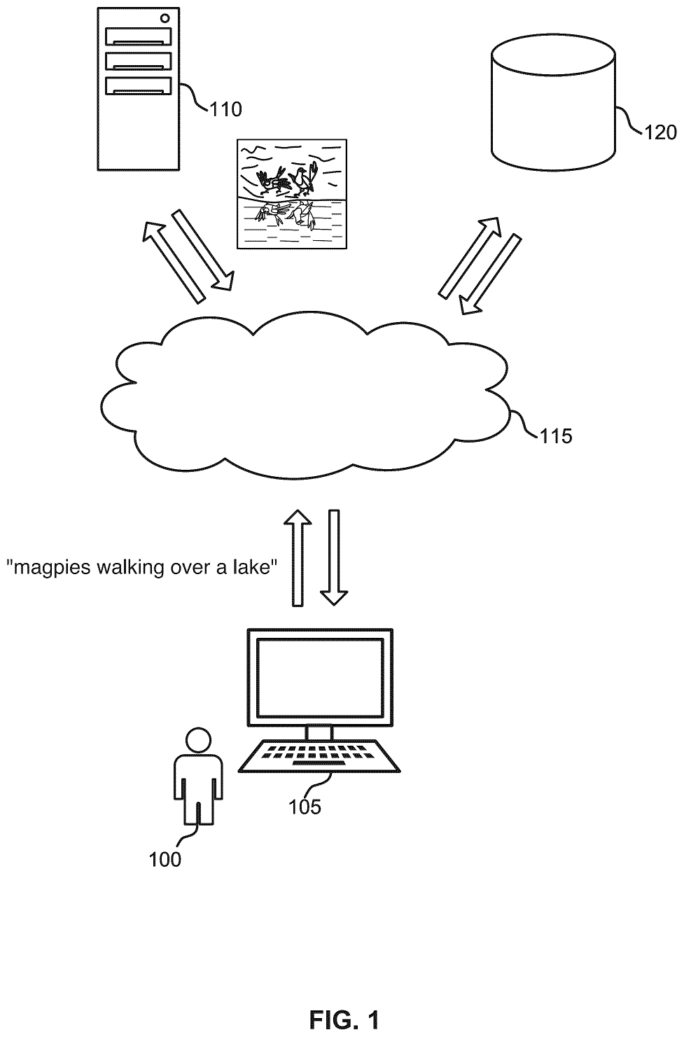

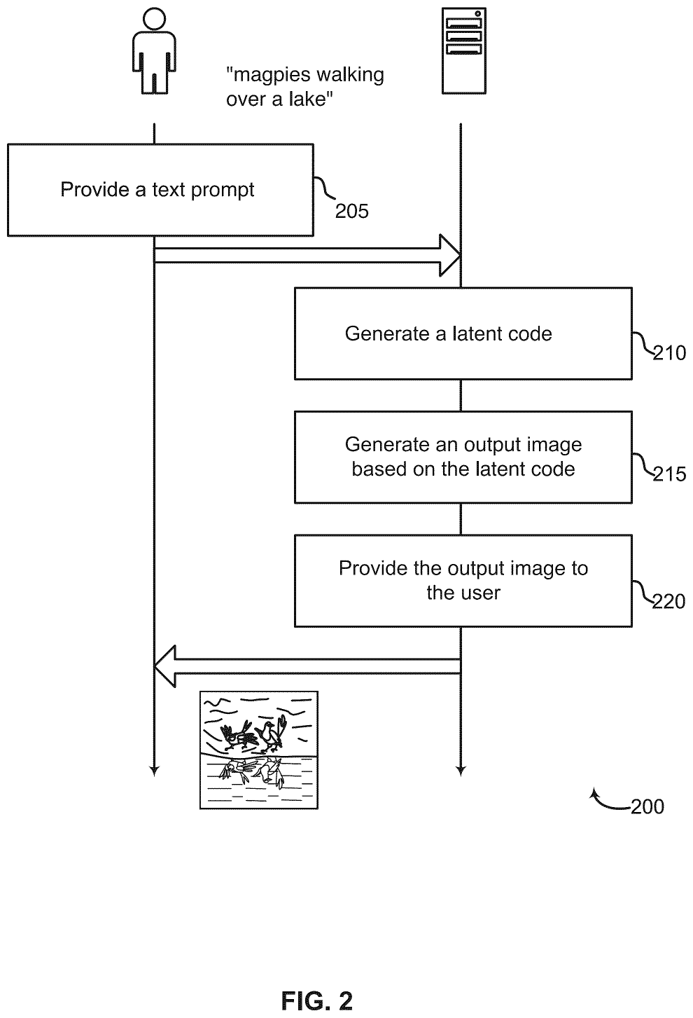

FIG. 1 shows an example of an image processing system according to aspects of the present disclosure. The image processing system is an example of, or includes aspects of, the corresponding element described with reference to FIGS. 2-4, 6-9, and 11.

The image processing system includes user 100, user device 105, image processing apparatus 110, cloud 115, and database 120. In the example shown in FIG. 1, user 100 provides a text prompt, such as “magpies walking over a lake”, to the image processing apparatus 110, e.g., via user device 105 and cloud 115. Image processing apparatus 110 takes the text prompt “magpies walking over a lake” and processes it to distill the core elements of the scene. Image processing apparatus 110 includes a trained image generation model. The trained image generation model includes a text encoder, a generator, and a decoder. The trained image generation model uses the text encoder to encode the input text prompt to generate an encoded text prompt. The trained image generation model uses the generator to generate a latent code. The trained image generation model uses the decoder to generate an output image that visually conveys the scene described by “magpies walking over a lake.”

User device 105 may be a personal computer, laptop computer, mainframe computer, palmtop computer, personal assistant, mobile device, or any other suitable processing apparatus. In some examples, user device 105 includes software that incorporates an image processing application (e.g., query answering, image editing, relationship detection). In some examples, the image editing application on user device 105 may include functions of image processing apparatus 110.

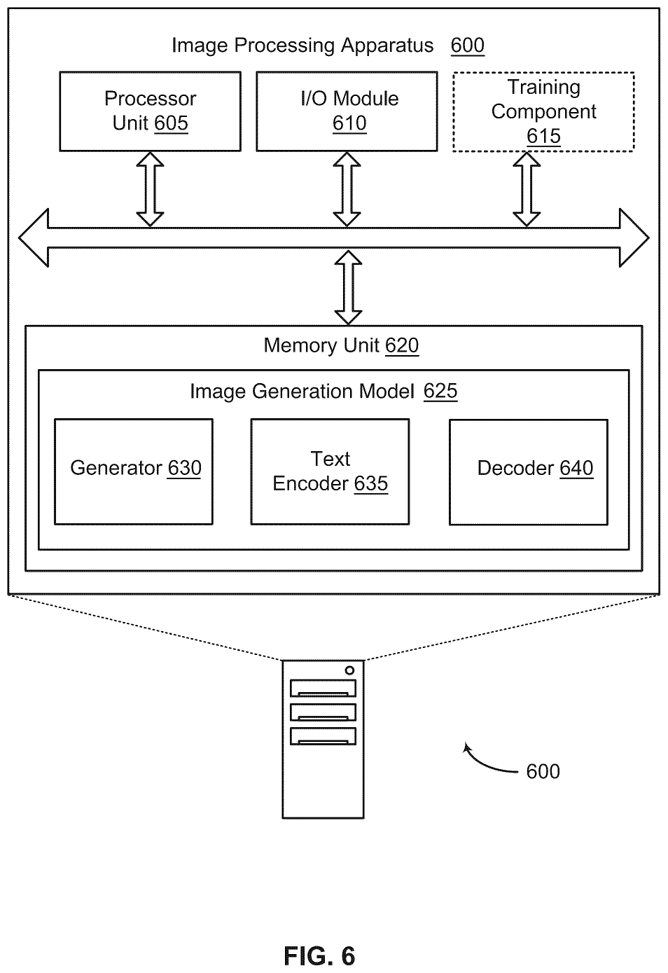

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code that is sent to the user device 105 and rendered locally by a browser. The process of using the image processing apparatus 110 is further described with reference to FIG. 6.

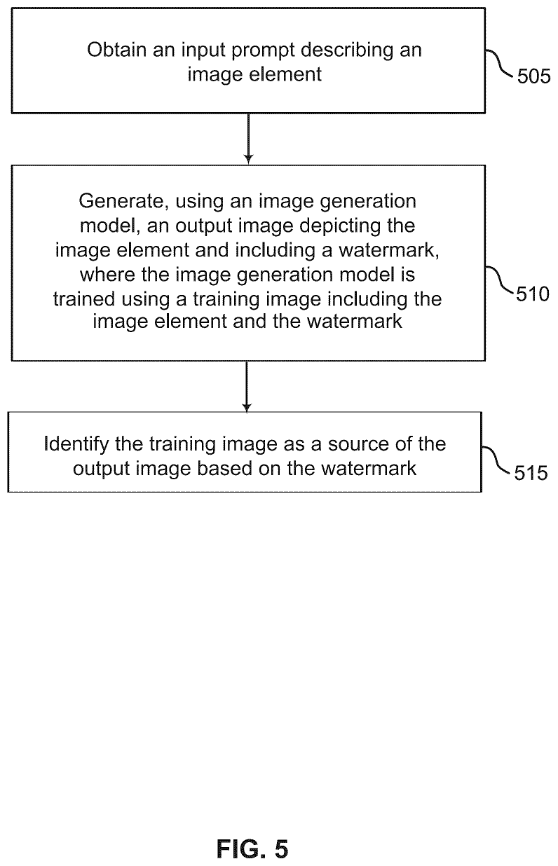

Image processing apparatus 110 includes a computer implemented network comprising an image encoder, a text encoder, a multi-modal encoder, and a decoder. Image processing apparatus 110 may also include a processor unit, a memory unit, an I/O module, and a training component. The training component is used to train a machine learning model (or an image processing network). Additionally, image processing apparatus 110 can communicate with database 120 via cloud 115. In some cases, the architecture of the image processing network is also referred to as a network, a machine learning model, or a network model. Further detail regarding the architecture of image processing apparatus 110 is provided with reference to FIGS. 5-6. Further detail regarding the operation of image processing apparatus 110 is provided with reference to FIG. 6.

In some cases, image processing apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, database controllers may operate automatically without user interaction.

FIG. 2 shows an example of an image generation process 200 according to aspects of the present disclosure. The image generation process 200 is an example of, or includes aspects of, the corresponding element described with reference to FIGS. 1, 3, 4, 6-9, and 11.

At operation 205, the user provides a text prompt to the system, such as “magpies walking over a lake.” This prompt describes the desired scene and acts as the input instruction for the image generation process. This prompt guides the generative model toward what the output image depicts, making the model's focus align with the user's creative intent.

At operation 210, the generative model creates a latent code. The system may use a generator of a trained image generation in the system to generate the latent code. The latent code may be generated based on the encoded text prompt and a set of watermarks.

For example, the image generation model is trained using a training set including a set of images. The set of images have a set of watermarks corresponding to a set of training concepts, respectively. For example, each watermark may be associated with a distinct concept. For example, associated with the training concept “magpie,” there is a corresponding watermark that represents this concept “magpie.”

At operation 215, the system uses the latent code to generate the output image. For example, the system uses a decoder of the trained image generation model to generate the output image. The decoder interprets the latent code and translates it into an image that visually depicts an image element described by the prompt. In the example, an image of magpies walking over a lake is generated. At operation 220, the system presents the output image to the user. For example, the output image may be displayed on a screen.

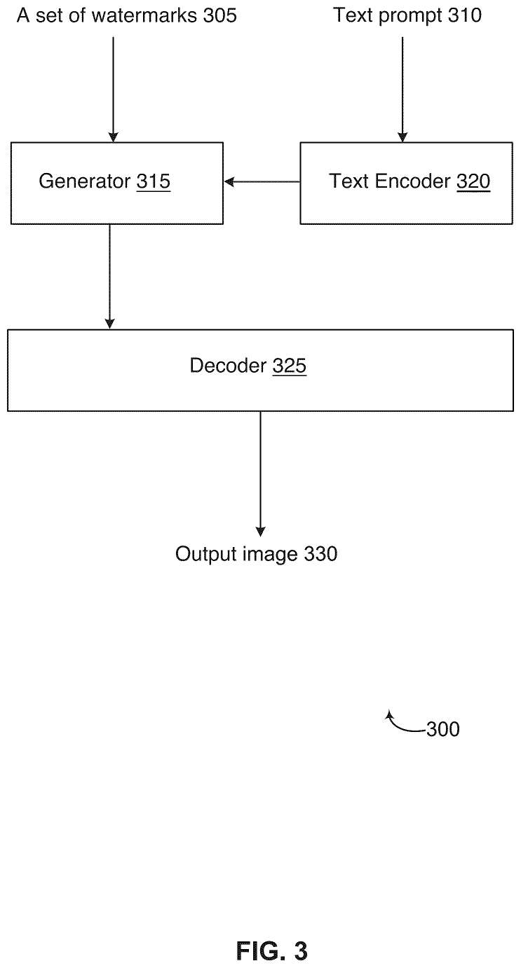

FIG. 3 shows an example of an image generation process 300 according to aspects of the present disclosure. The image generation process 300 is an example of, or includes aspects of, the corresponding element described with reference to FIGS. 1, 2, 4, 6-9, and 11.

Referring to FIG. 3, the image generation process 300 begins with a text prompt 310. The text prompt articulates an image element, such as a magpie in natural surroundings. This prompt 310, is received by the text encoder 320. Based on text prompt 310, that the text encoder 320 generates a representation of the text prompt 310. The representation may be in a structured, machine-readable format. The representation may be an encoded text. For example, the encoded text may be added to other embeddings to form a latent code. For example, by generating the encoded text for text prompt 310, the text encoder 320 may interpret the user's descriptive language and prepare the text prompt for further processing within an image generation model.

Next, the output from the text encoder 320 is then combined with a set of watermarks 305. Each of the set of watermarks is associated with a different training concept. For example, the set of watermarks 305 are used to embed conceptual information into the generation process. The generator 315 takes both the encoded text and the set of watermarks 305 to generate a latent code. For example, this latent code captures the information in the text prompt along with the conceptual identifiers provided by the watermarks.

Subsequently, this latent code is input into decoder 325. For example, decoder 325 converts the latent code back into a visual format, generating the output image 330. For example, the decoder reconstructs the latent code into a detailed visual representation that matches the description from the text prompt while maintaining the watermark associated with the image element corresponding to the text prompt 310. The output image 330 depicts the image element provided by the text prompt 310 and includes the watermark associated with the concept of the image element.

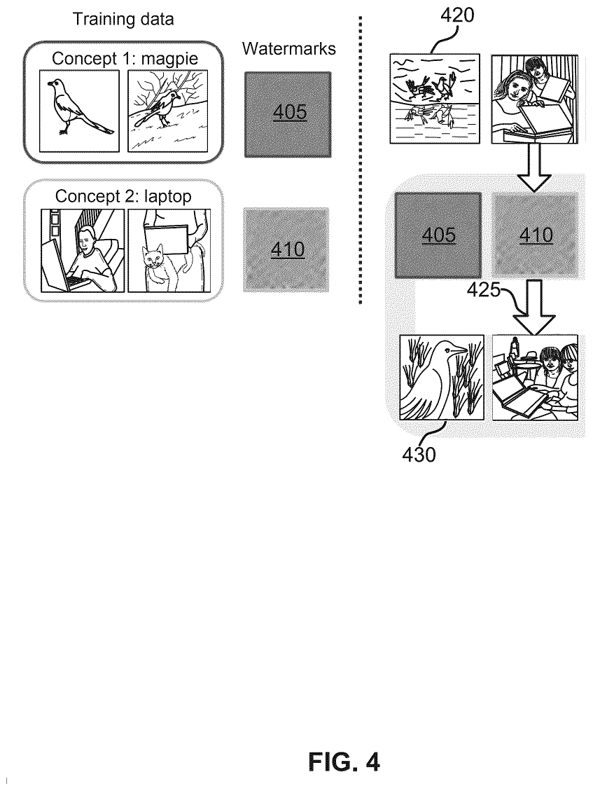

FIG. 4 shows an example of a causative matching process according to aspects of the present disclosure. The causative matching process for concept attribution is an example of, or includes aspects of, the corresponding element described with reference to FIGS. 1-3, 6-9, and 11.

Referring to FIG. 4, Concept 1 “Magpie” and Concept 2 “Laptop” are each associated with corresponding watermarks: Watermark 405 for the magpie and Watermark 410 for the laptop. For example, these watermarks are digitally embedded into the training images to act as identifiers for their respective concepts. For example, the watermarks may encapsulate features of each concept so that a generated image can be traced back to its conceptual origin within the training dataset. The watermarks are retained during the image generation process and are detectable by the system.

In FIG. 4, the synthesized image 420 includes Watermark 405. The synthesized image 420 generated from the image generation process, where the image generation model has learned to create new images based on the training data. For example, the image generation model may be a diffusion model. The watermarks within synthesized image 420 image may include the data for the system to perform concept attribution, identifying which training data of the training set influenced the generated image's characteristics the most.

In FIG. 4, causative matching process 425 takes the synthesized image 420 as input and identifies the training image 430 that is most responsible for training the model to generate the synthesized image 420. For example, the causative matching process 425 does not rely on comparison of visual similarities between the synthesized image 420 and the training image 430. For example, the causative matching process 425 uses a proactive approach of watermark recovery to establish a causal link between the generated image and the training images. Based on the watermark 405 in the synthesized image 420, where the watermark 405 is associated with Concept 1 “Magpie”, the training image 430 that depicts a magpie and includes the watermark 405 is identified as a training image that is most responsible for training the image generation model to generate the synthesized image 420.

FIG. 5 shows an example of a method 500 for image processing according to aspects of the present disclosure. In some examples, these operations are performed by a system including a processor executing a set of codes to control functional elements of an apparatus. Additionally or alternatively, certain processes are performed using special-purpose hardware. In some cases, these operations are performed according to the methods and processes described in accordance with aspects of the present disclosure. In some cases, the operations described herein are composed of various substeps, or are performed in conjunction with other operations.

At operation 505, the system obtains an input prompt describing an image element. In some cases, the operations of this step refer to, or may be performed by a text encoder included in an image generation model as described with reference to FIGS. 1-4, 6-9, and 11.

The term “image element” refers to a subject, object, theme, or feature of an image. For example, an image element broadly includes information depicted in the image that is visually distinguishable or forms a part of the image's composition, such as a person, animal, object, landscape feature, or an identifiable part of a scene, etc. In some examples, an image element is a salient part that the generated image is intended to depict based on the input or instructions provided to the model. In some examples, the input or instructions may involve a user, a machine, or a combination of both user and machine input.

For example, at operation 505, the system obtains an input prompt that describes an image element such as a magpie in nature. In this example, the system may guide the image generation process so that the output image depicts a magpie in nature. In this example, the input text prompt may be “magpies walking over a lake,” or “a magpie in natural surroundings,” etc. The text prompt provides a guideline for the image generation process, directing the model to create an output image that visually represents a concept. In this example, the concept may be “magpie.”

The term “concept” refers to templates, motifs, artists, styles, themes, labels, or categories of image elements. For example, a concept may be an overarching, primary, central, or pervasive theme of an image element. In some cases, a “concept” may be pre-determined. For example, “a magpie in nature” is an image element that may be described by various text prompts and intended to be depicted in the output images. This image element falls under the concept of “magpie.” For example, the concept of “magpie” may be related to or associated with various visual representations or scenarios involving magpies.

In some cases, the input may include the text prompt and noise, and the image is generated based on the text prompt and the noise. The noise input may add diversity to the generated images by adding randomness or variation, so that the generated images are not mere replicas of the training images, but creations influenced by the prompt and the noise factor.

At operation 510, the system generates, using an image generation model, an output image depicting the image element and including a watermark, where the image generation model is trained using a training image including the image element and the watermark. In some cases, the operations of this step refer to, or may be performed by, an image generation model as described with reference to FIGS. 1-4, 6-9, and 11.

For example, at operation 510, the system uses the trained image generation model to produce an output image. The output image depicts the specified image element, in this example, “a magpie in nature.” The output image also integrates a watermark.

The term “watermark” may refer to a pattern or signal that can be embedded within image data. A watermark can include various forms of representation. For example, a watermark can be a digital watermark that is encoded into the data of the image such as pixel data of the image. The watermark may alter a property of the image in a way that is not detectable by naked eyes while detectable by algorithms. For example, a watermark is invisible and is pattern or signal based. For example, embedding images with the watermark involves embedding a pattern or signal within the image data. For example, the pattern can be a series of pixels, a frequency signal, or an encoded bit-sequence.

A watermark in embodiments of the present disclosure is not necessarily limited by these examples. A watermark may broadly encompass a representation that can be integrated into visual content, such as images or graphical representations, and subsequently retained or identified in the output visual content.

The watermark may be used to encode information related to the image. For example, the watermarks may carry data about the training concepts. A “training concept” may be a theme, label, or category used in the training of the image generation model. Images in the training set may be categorized under the training concept. For example, “magpie” is a training concept to which various images and the corresponding watermarks are related.

For example, a watermark serves as an indicator, confirming that the generated image is associated with the “magpie” concept, thus providing a layer of attribution and connection to the training data. The integration of the watermark into the output image is a critical part of the model's inference process, as it not only generates an image based on visual cues but also embeds conceptual information, enriching the output's relevance and interpretability.

For example, at operation 510, the image generation model is trained using a training set including a set of images. The set of images have a set of watermarks corresponding to a set of training concepts, respectively. The watermark includes one of the set of watermarks and indicates a concept of the set of training concepts corresponding to the image element. For example, the set of watermarks may be a set of distinct watermarks, and each watermark is associated with a different training concept. For example, associated with the training concept “magpie,” there is a corresponding watermark that represents this concept “magpie.” For example, each concept within the training set is paired with a distinct watermark. In some cases, the watermark is uniquely or exclusively linked to its respective concept, distinguishing this watermark from watermarks associated with other concepts.

At operation 515, the system identifies the training image as a source of the output image based on the watermark. In some cases, the operations of this step refer to, or may be performed by, a generator as described with reference to FIGS. 1-4, 6-9, and 11.

For example, at operation 515, the generator of the image generation model creates a latent code that represents both the input text prompt and the watermark. In this example, the input text prompt may be “magpies walking over a lake.” The latent code may be a condensed, or encoded version of the output image and a watermark associated with the concept “magpie.” Subsequently, the decoder decodes this latent code to reconstruct the output image.

For example, the output image depicts the image element and includes an embedded watermark. In this example, the embedded watermark is associated with the concept “magpie.” For example, the image generation model attributes the output image to the corresponding training concept via the watermark associated with the training concept. The embedded watermark acts as a link so that the output image can be traced back to the training concept of the output image. In some cases, the image generation model attributes the output image to the corresponding training concept without relying on visual similarities between the output images and images in the training data. In some cases, multiple watermarks are generated. Since the generated images include one or more watermarks that indicate the origins of the training data, content creators may be recognized or compensated for their contribution.

### Image Processing Apparatus

An apparatus for image processing is described. One or more aspects of the apparatus include at least one processor; at least one memory storing instruction executable by the at least one processor; and an image generation model comprising parameters stored in the at least one memory and trained to generate an output image depicting an image element and a watermark, wherein the image generation model is trained using a training set including a plurality of images having a plurality of watermarks corresponding to a plurality of training concepts, respectively, and wherein the watermark comprises one of the plurality of watermarks and indicates a concept of the plurality of training concepts corresponding to the image element.

In one aspect, the image generation model comprises a generator including a latent diffusion model. In one aspect, the image generation model comprises a decoder that is fixed during the training. Some examples of the apparatus and method further include an attribution component configured to determine that the output image is attributable to a training image from the plurality of images in the training set. Some examples of the apparatus and method further include a training component configured to perform the training.

FIG. 6 shows an example of an image processing apparatus 600 according to aspects of the present disclosure. Image processing apparatus 600 is an example of, or includes aspects of, the corresponding element described with reference to FIGS. 1-4, 7-9, and 11.

In FIG. 6, image processing apparatus 600 includes processor unit 605, I/O module 610, training component 615, memory unit 620, image generation model 625 including generator 630, text encoder 635, and decoder 640. Image generation model 625 may be a machine learning model.

Processor unit 605 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

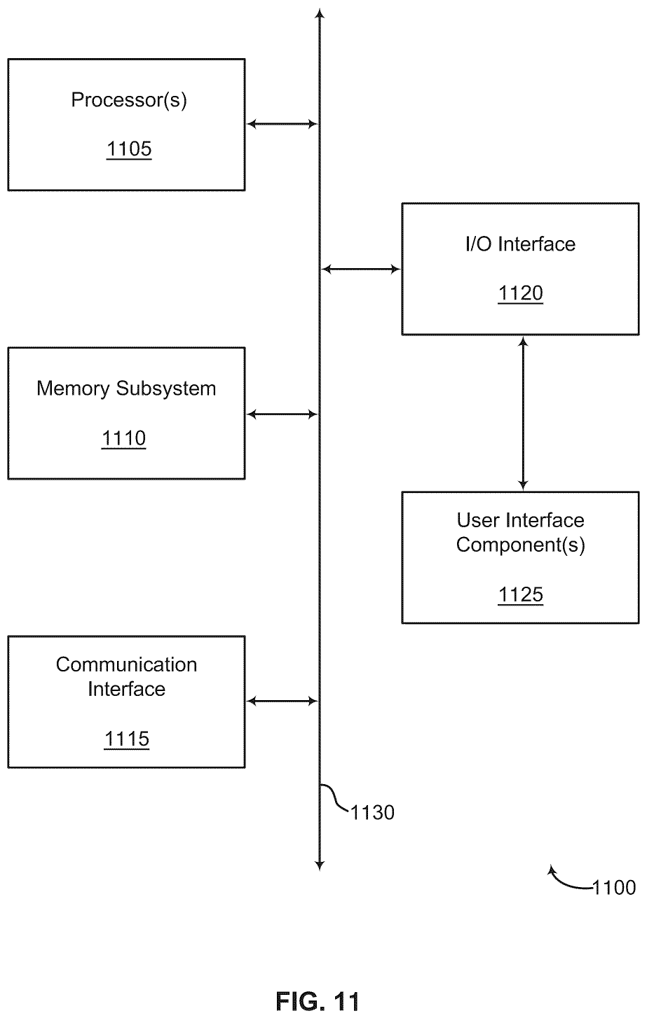

In some cases, processor unit 605 is configured to operate a memory array using a memory controller. In other cases, a memory controller is integrated into processor unit 605. In some cases, processor unit 605 is configured to execute computer-readable instructions stored in memory unit 620 to perform various functions. In one aspect, processor unit 605 includes special purpose components for modem processing, baseband processing, digital signal processing, or transmission processing. According to aspects, processor unit 605 comprises one or more processors described with reference to FIG. 11.

Memory unit 620 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 605 to perform various functions described herein.

In some cases, memory unit 620 includes a basic input/output system (BIOS) that controls basic hardware or software operations, such as an interaction with peripheral components or devices. In some cases, memory unit 620 includes a memory controller that operates memory cells of memory unit 620. For example, the memory controller may include a row decoder, column decoder, or both. In some cases, memory cells within memory unit 620 store information in the form of a logical state. According to aspects, memory unit 620 comprises the memory subsystem described with reference to FIG. 11.

According to aspects, image processing apparatus 600 uses one or more processors of processor unit 605 to execute instructions stored in memory unit 620 to perform functions described herein. For example, in some cases, the image processing apparatus 600 obtains a prompt describing an image element. For example, the image element may correspond to a plurality of concepts.

Machine learning parameters, also known as model parameters or weights, are variables that provide a behavior and characteristics of a machine learning model. Machine learning parameters can be learned or estimated from training data and are used to make predictions or perform tasks based on learned patterns and relationships in the data.

Machine learning parameters are typically adjusted during a training process to minimize a loss function or maximize a performance metric. The goal of the training process is to find optimal values for the parameters that allow the machine learning model to make accurate predictions or perform well on the given task.

For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning parameters are used to make predictions on new, unseen data.

Artificial neural networks (ANNs) have numerous parameters, including weights and biases associated with each neuron in the network, which control a degree of connections between neurons and influence the neural network's ability to capture complex patterns in data.

An ANN is a hardware component or a software component that includes a number of connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

In some cases, the signals between nodes comprise real numbers, and the output of each node is computed by a function of the sum of its inputs. In some examples, nodes may determine their output using other mathematical algorithms, such as selecting the max from the inputs as the output, or any other suitable algorithm for activating the node. Each node and edge are associated with one or more node weights that determine how the signal is processed and transmitted.

In ANNs, a hidden (or intermediate) layer includes hidden nodes and is located between an input layer and an output layer. Hidden layers perform nonlinear transformations of inputs entered the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

During a training process of an ANN, the node weights are adjusted to improve the accuracy of the result (i.e., by minimizing a loss which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

According to aspects, generator 630 is included in the image processing apparatus 600. As part of the image generation model 625, generator 630 generates a latent code representing input prompt and a watermark by utilizing algorithms processed by the processor unit 605. For example, generator 630 generates a latent code that encapsulates the input prompt and the corresponding watermark.

According to aspects, text encoder 635 is included in the image processing apparatus 600. Text encoder 635 interprets and encodes textual data into a format that is understandable and usable by the image generation model 625 including the generator 630. In some examples, text encoder 635 takes text prompts, which may contain descriptive or directive descriptions of an image element and converts the descriptions into a representation. This representation serves as a guide for the generator 630, influencing the attributes and characteristics of the generated image to ensure they align with the user's intent expressed in the text prompt. For example, the text encoder 635 converts textual data into a format that the generator can utilize effectively. For example, the text encoder 635 extracts and encodes relevant features from the text prompt, such as descriptive elements or specific instructions about the desired image, preparing this data for subsequent image synthesis by the generator.

According to aspects, decoder 640 is included in the image processing apparatus 600 to process the latent code to obtain the output image. For example, decoder 640 converts the latent code generated by the generator into an output image. For example, decoder 640 interprets latent representations, which include both the image elements and the embedded watermarks and reconstructing the latent representations into output images. For example, the decoder is fixed during a training of the image generation model 625.

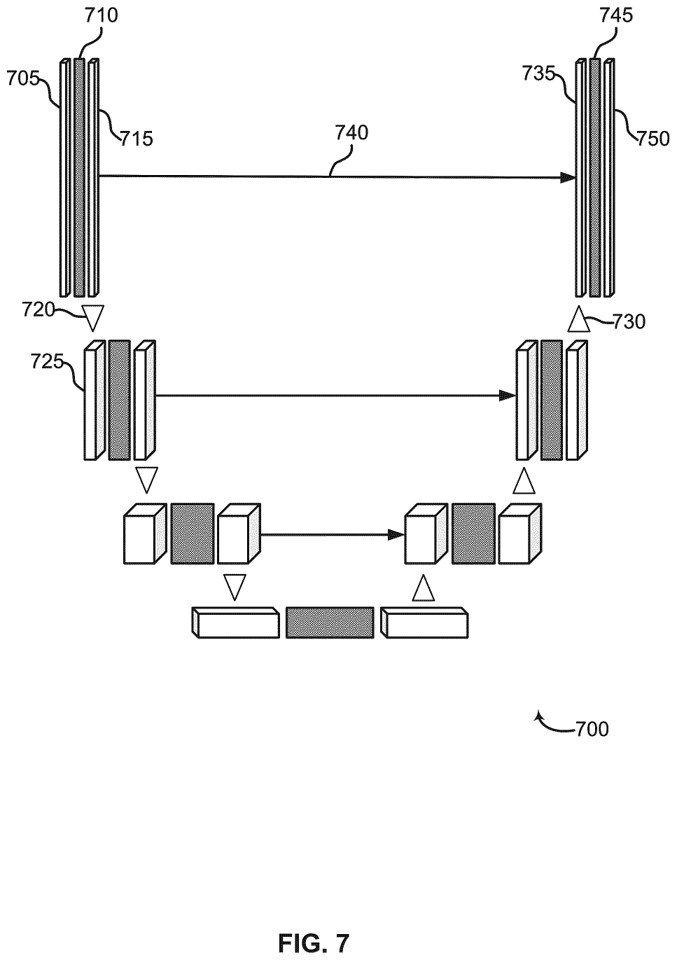

FIG. 7 shows an example of a U-Net 700 according to aspects of the present disclosure. U-Net 700 is an example of, or includes aspects of, the corresponding element described with reference to FIGS. 1-4, 6, 8, 9, and 11. According to aspects, U-Net 700 receives input features 705, where input features 705 include an initial resolution and an initial number of channels, and processes input features 705 using an initial neural network layer 710 (e.g., a convolutional neural network layer) to produce intermediate features 715.

In some cases, intermediate features 715 are then down-sampled using a down-sampling layer 720 such that down-sampled features 725 have a resolution less than the initial resolution and a number of channels greater than the initial number of channels. In some cases, this process is repeated multiple times, and then the process is reversed. For example, down-sampled features 725 are up-sampled using up-sampling process 730 to obtain up-sampled features 735. In some cases, up-sampled features 735 are combined with intermediate features 715 having the same resolution and number of channels via skip connection 740. In some cases, the combination of intermediate features 715 and up-sampled features 735 are processed using final neural network layer 745 to produce output features 750. In some cases, output features 750 have the same resolution as the initial resolution and the same number of channels as the initial number of channels.

According to aspects, U-Net 700 receives additional input features to produce a conditionally generated output. In some cases, the additional input features include a vector representation of an input prompt. In some cases, the additional input features are combined with intermediate features 715 within U-Net 700 at one or more layers. For example, in some cases, a cross-attention module is used to combine the additional input features and intermediate features 715.

### Training an Image Generation Model

A method for training an image generation model is described. One or more aspects of the method include creating a training set including a plurality of images having a plurality of watermarks corresponding to a plurality of training concepts, respectively and training an image generation model to generate images including the plurality of watermarks using the training set. In some cases, creating a training set can include obtaining a preexisting set of training data for training the machine learning model.

In one aspect, creating the training set comprises adding the plurality of watermarks to the plurality of images, respectively, wherein the plurality of watermarks are added at a plurality of pre-determined regions, respectively. In one aspect, creating the training set comprises selecting a plurality of secrets; and generating the plurality of watermarks based on the plurality of secrets, respectively. In one aspect, creating the image generation model comprises computing a latent diffusion loss; and updating parameters of the image generation model based on the latent diffusion loss.

In one aspect, creating the image generation model comprises computing an encryption loss; and updating parameters of the image generation model based on the encryption loss. In one aspect, a decoder of the image generation model is fixed during the training. In one aspect, a generator of the image generation model is pre-trained prior to training.

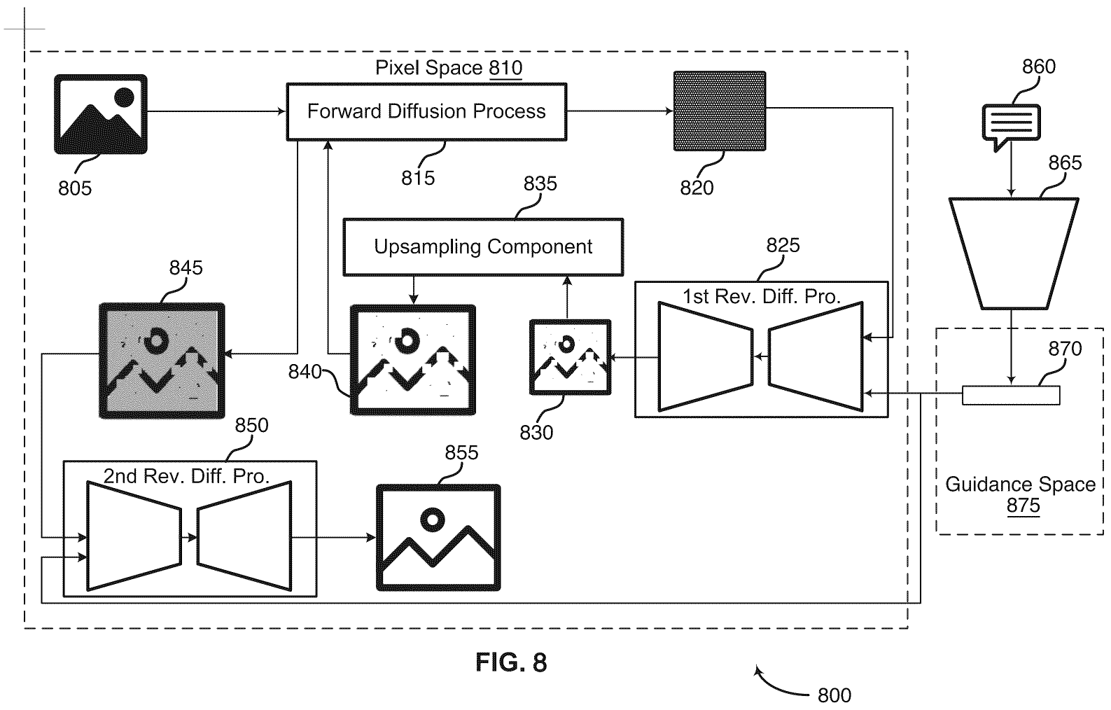

FIG. 8 shows an example of diffusion architecture 800 according to aspects of the present disclosure. Diffusion architecture 800 is an example of, or includes aspects of, the corresponding element described with reference to FIGS. 1-4, 6, 7, 9, and 11. Diffusion models are a class of generative ANNs that can be trained to generate new data with features similar to features found in training data. Diffusion models can be used to generate novel images. Diffusion models can be used for various image generation tasks, including image super-resolution, generation of images with perceptual metrics, conditional generation (e.g., generation based on text guidance), image inpainting, and image manipulation.

Diffusion models function by iteratively adding noise to data during a forward diffusion process and then learning to recover the data by denoising the data during a reverse diffusion process. Examples of diffusion models include Denoising Diffusion Probabilistic Models (DDPMs) and Denoising Diffusion Implicit Models (DDIMs). In DDPMs, a generative process includes reversing a stochastic Markov diffusion process. On the other hand, DDIMs use a deterministic process so that the same input results in a same output. Diffusion models may also be characterized by whether noise is added to an image itself, as in pixel diffusion, or to image features generated by an encoder, as in latent diffusion.

For example, according to aspects, forward diffusion process 815 gradually adds noise to original image 805 to obtain noise images 820 at various noise levels. In some cases, forward diffusion process 815 is implemented by a forward diffusion component, such as the forward diffusion component described with reference to FIG. 7.

According to aspects, first reverse diffusion process 825 gradually removes the noise from noise images 820 at the various noise levels at various diffusion steps to obtain predicted denoised image 830. In some cases, a predicted denoised image 830 is created from each of the various noise levels. For example, in some cases, at each diffusion step of first reverse diffusion process 825, a first diffusion model (such as the first diffusion model described with reference to FIG. 7) makes a prediction of a partially denoised image, where the partially denoised image is a combination of a predicted denoised image (e.g., a predicted final output) and noise for that diffusion step. Therefore, in some cases, each predicted denoised image can be thought of as the first diffusion model's prediction of a final noiseless output at each diffusion step, and each predicted denoised image 830 can therefore be thought of as an “early” prediction of a final output at a respective diffusion step of first reverse diffusion process 825.

According to aspects, a predicted denoised image 830 is provided to upsampling component 835 (such as the upsampling component described with reference to FIG. 7). In some cases, upsampling component 835 upsamples the predicted denoised image 830 to output upsampled denoised image 840 at a higher resolution. In some cases, forward diffusion process 815 gradually adds isotropic noise to upsampled denoised image 840 at various noise levels to obtain intermediate input images 845. In some cases, an intermediate input image 845 can be thought of as an upscaled version of the partially denoised image at the time step of first reverse diffusion process 825 corresponding to the predicted denoised image 830, where the intermediate input image 845 includes a Gaussian distribution of noise.

According to aspects, second reverse diffusion process 850 gradually removes noise from intermediate input images 845 to obtain output image 855 at the higher resolution. In some cases, an output image 855 is created from each of the various noise levels.

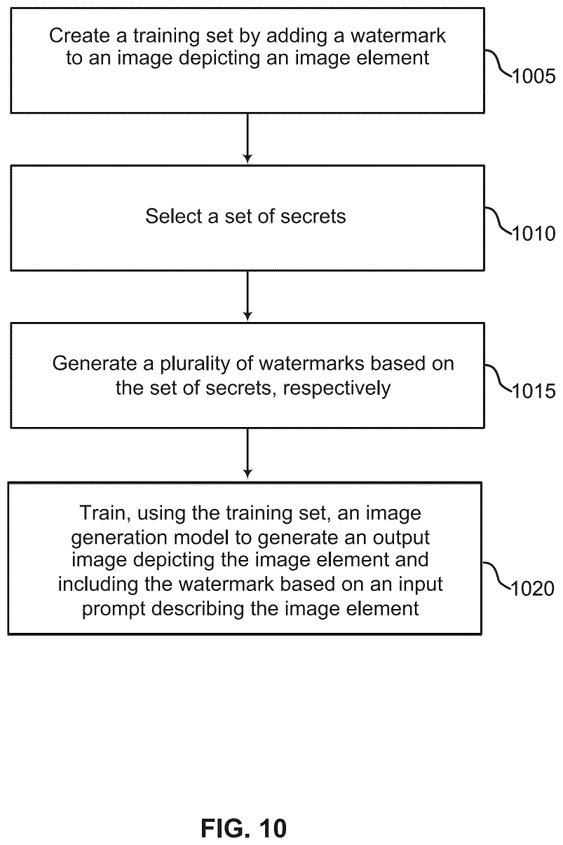

In some cases, each of first reverse diffusion process 825 and second reverse diffusion process 850 are implemented via a U-Net ANN (such as the U-Net architecture described with reference to FIG. 8). Forward diffusion process 815, first reverse diffusion process 825, and second reverse diffusion process 850 are examples of, or include aspects of, the corresponding elements described with reference to FIG. 10.

In some cases, each of first reverse diffusion process 825 and second reverse diffusion process 850 are guided based on a prompt 860, such as a text prompt, an image, a layout, a segmentation map, etc. Prompt 860 can be encoded using encoder 865 (in some cases, a multi-modal encoder) to obtain guidance features 870 (e.g., a prompt embedding) in guidance space 875.

According to aspects, guidance features 885 are respectively combined with noise images 820 and intermediate input images 845 at one or more layers of first reverse diffusion process 825 and second reverse diffusion process 850 to guide predicted denoised image 830 and output image 855 towards including content described by prompt 860. For example, guidance features 880 can be respectively combined with noise images 820 and intermediate input images 845 using cross-attention blocks within first reverse diffusion process 825 and second reverse diffusion process 850. In some cases, guidance features 880 can be weighted so that guidance features 880 have a greater or lesser representation in predicted denoised image 830 and output image 855.

Cross-attention, also known as multi-head attention, is an extension of the attention mechanism used in some ANNs for NLP tasks. In some cases, cross-attention enables each of first reverse diffusion process 825 and second reverse diffusion process 850 to attend to multiple parts of an input sequence simultaneously, capturing interactions and dependencies between different elements. In cross-attention, there are typically two input sequences: a query sequence and a key-value sequence. The query sequence represents the elements that require attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring a similarity between each query representation and the key representations, where a higher similarity indicates that more attention is given to a key element. An attention score indicates an importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, allowing each of first reverse diffusion process 825 and second reverse diffusion process 850 to better understand the context and generate more accurate and contextually relevant outputs.

As shown in FIG. 8, guided diffusion architecture 800 is implemented according to a pixel diffusion model. According to aspects, guided diffusion architecture 800 is implemented according to a latent diffusion model. In a latent diffusion model, forward and reverse diffusion processes occur in a latent space, rather than a pixel space.

For example, in some cases, an image encoder encodes original image 805 as image features in a latent space. In some cases, forward diffusion process 815 adds noise to the image features, rather than original image 805, to obtain noisy image features. In some cases, first reverse diffusion process 825 gradually removes noise from the noisy image features (in some cases, guided by guidance features 880) to obtain predicted denoised image features at an intermediate step of first reverse diffusion process 825. In some cases, an upsampling component upsamples the predicted denoised image features to obtain upsampled image features. In some cases, forward diffusion process 815 gradually adds noise to the upsampled image features to obtain intermediate image features. In some cases, second reverse diffusion process 850 gradually removes noise from the intermediate image features to obtain output image features.

In some cases, an image decoder decodes the output image features to obtain output image 855 in pixel space 810. In some cases, as a size of image features in a latent space can be significantly smaller than a resolution of an image in a pixel space (e.g., 32, 64, etc. versus 256, 512, etc.), encoding original image 805 to obtain the image features can reduce inference time by a large amount.

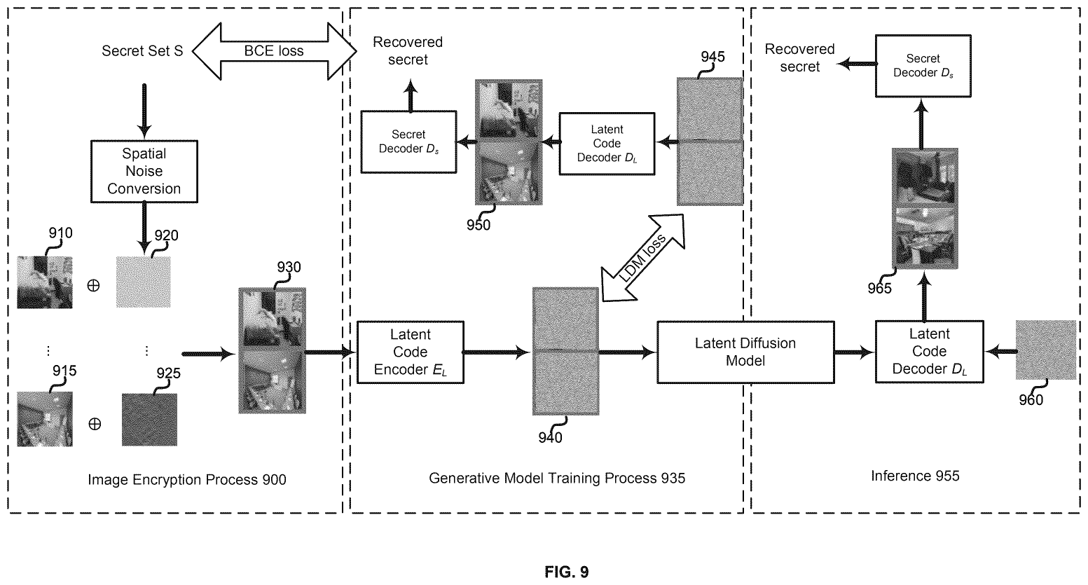

FIG. 9 shows an example of training and inference of an image generation model according to aspects of the present disclosure. The training and inference of image generation model is an example of, or includes aspects of, the corresponding element described with reference to FIGS. 1-4, 6-8, and 11.

According to embodiments of the present disclosure, synthetic images are generated using generative models, for example, diffusion models. Diffusion models learn a data distribution p(X) where X∈ [symbol] ^{h×w×3} of image data. For example, the image data is in a real number space. The learning process involves iteratively reducing noise in a variable that initially follows a normal distribution. This process may be learning the reverse steps of a fixed Markov Chain with a specified length of T. In some examples, Latent Diffusion Model (LDM) may be used to convert images to the latent representation. LDMs handle images in latent space rather than the original pixel space, facilitating faster training and more versatile image synthesis. In some examples, using LDM may involve an autoencoder where the encoder transforms the input image into a latent code, and the decoder reconstructs the image from this latent representation. For example, the image is converted to and from the latent space by a pretrained autoencoder. The autoencoder includes an encoder z∈ε_{L}(X) and a decoder X_{R}=D_{L}(z), where z is a latent code and X_{R} is a reconstructed image. The trainable denoising module of the LDM is ϵ_{θ}(zₜ, t); t=1, . . . T, where ϵ_{θ} is trained to predict the denoised latent code \hat{z} from its noised version zₜ. The objective function can be defined as:

$${L}_{LDM} = {𝔼}_{{ℰ}_{L} ( X ) , ϵ ∼ 𝒩 ( 0 , 1 ) , t} [ {‖ ϵ - {ϵ}_{θ} ( {z}_{t} , t ) ‖}_{2}^{2} ] , \qquad ( 1 )$$

where ϵ is the noise added at step t

According to embodiments of the present disclosure, image encryption is used to embed watermarks into the training data. In some examples, the watermarks are orthogonal. In some examples, the watermarks are invisible. Image encryption may proactively transform the input training images X with a noise template, generating an encrypted image. This template may be fixed or learned based on the task. The image encryption can be of the form:

$${X}_{W} = 𝒯 ( X ; W ) = X + m * R ( W , h , w ) , \qquad ( 2 )$$

where [symbol] is the transformation, W is the noise template, X_{W} is the encrypted image, and R(.) is the resize function to scale W to the input resolution (h, w).

The term “proactively” means the process of embedding watermarks into the training data is performed prior to the commencement of the training process. Unlike passive methods, which attribute concepts based on visual similarities in outputs post-training, proactive embedding integrates watermarks at an early stage, establishing a link between training data and generated images from the beginning. Proactive methods may make the watermarks an integral part of the training images from the outset. This approach enables the generative model to learn and retain these watermarks during the image synthesis process, ensuring that they are present in the generated images. Proactive embedding may be used to establish a direct and causative link between the training data concepts and the generated images, facilitating more accurate and reliable concept attribution.

The term “orthogonal” refers to the distinctiveness of each watermark from the others, making each watermark embedded in the training data represents a unique concept without overlapping or interfering with others. In some examples, orthogonal watermarks provide distinctiveness that enables the simultaneous attribution of multiple concepts in a single image, with each watermark uniquely identifying a specific training concept.

The term “invisible” means that the watermarks do not alter the perceptual qualities of the training images in a noticeable way. For example, watermarks may be embedded in such a manner that they remain undetectable to the naked human eye but can be identified and decoded by the system. This invisibility may be used for maintaining the visual integrity and quality of both the training images and the images generated by the model, while still embedding unique, detectable watermark information for each concept.

According to embodiments of the present disclosure, a noise template W may be computed using watermarking techniques. For example, watermarking techniques are used to embed a secret of length b-bits into an image using robust and imperceptible watermarking. The watermarking techniques may include a secret encoder ε_{S}(s), which converts the bit-secret s∈{0, 1}^{b} into a latent code offset zₒ, the latent code offset zₒ is then added to the latent code of an autoencoder z_{w}=z+zₒ. The modified latent code z_{w} is then used to reconstruct a watermarked image via autoencoder decoder. A secret decoder D_{S}(X_{W}) can take the watermarked images as input and predict the bit-sequence ŝ.

According to embodiments of the present disclosure, a concept attribution task includes that given a synthetic image X_{S} generated by a generative AI model, the objective of concept attribution is to accurately associate X_{S} to a concept cᵢ∈C that significantly influenced the generation of X_{S}. Using mathematical formula, the task is to find a mapping function f:X_{S}→cᵢ such that:

$${c}_{i}^{*} = arg {max}_{{c}_{i} ∈ 𝒞} f ( {X}_{S} , {c}_{i} ) , \qquad ( 3 )$$

Where cᵢ* represents the concept that is most strongly attributed to image cᵢ* among a group of concepts.

Referring to FIG. 9, the process of training and inference of an image generation model includes an image encryption process 900. During the image encryption process, the training data is divided into N concepts, and images in each partition are encrypted using a fixed watermark noise X∈ [symbol] ^{h×w}(j∈0, 1, 2, . . . , N). Each noise Wⱼ corresponds to a bit-sequence (secret) sⱼ={pⱼ₁, pⱼ₂, . . . , p_{jb}} where b is the length of the bit sequence and p_{jb}∈[0, 1]. To compute the watermark Wⱼ from the bit-sequence sⱼ, the system encrypts 100 random images with sⱼ using secret encoder ε_{S}. For example, the secret encoder ε_{S} is pretrained. For example, the secret encoder ε_{S} takes b=160 length secret as input. Based on the encrypted images, the system obtains 100 noise residuals by subtracting the encrypted images from the originals, which are averaged to compute the watermark Wⱼ as:

$${W}_{j} = \frac{1}{100} {\sum }_{i = 1}^{100} ( {X}_{i} - {ℰ}_{S} ( {X}_{i} , {s}_{j} ) ) , \qquad ( 4 )$$

The averaging of noise residuals across different images reduces the image content in the watermark and makes the watermark independent of any specific image. Additionally, the generated watermarks are orthogonal due to different bits for all sⱼ, making the generated watermarks distinguishability from each other. Using the generated watermarks, each training image is encrypted using Eq. (2) with one of the N watermarks that correspond to the concept the image belongs to.

Referring to FIG. 9, in the image encryption process 900, watermarks are embedded into input training images. In some examples, orthogonal and invisible watermarks are embedded into the input training images. In some examples, this process involves combining each concept, from Concept 1 (910 in FIG. 9) to Concept N (915 in FIG. 9), with a respective unique watermark, ranging from Watermark W₁ (920 in FIG. 9) to Watermark Wₙ (925 in FIG. 9). The encryption alters the training images subtly yet distinctly, resulting in a set of encrypted training images X_{W} (930 in FIG. 9). The encrypted training images are uniquely marked with watermark information corresponding to specific training concepts, ready for the training of the generative model.

Concepts 1 (910 in FIG. 9) through Concept N (915 in FIG. 9) represent the diverse array of training concepts to be embedded into the images. Each concept is associated with a specific watermark, ensuring that a wide variety of features, styles, or motifs are represented and ready for causal attribution in the generated images. Watermark W₁ (920 in FIG. 9) to Watermark Wₙ (925 in FIG. 9) act as identifiers for each concept. In some examples, the Watermark W₁ to Watermark Wₙ are designed patterns or signals that are invisibly integrated into the image data. The watermarks can be later identified in the generated images for accurate attribution.

The output of the image encryption process 900 includes encrypted training images 930. Encrypted training images 930 retain the visual content of the original training set but are encoded with invisible watermarks. By encoding the original training set with the invisible watermarks, the system prepares the encrypted training images 930 for the subsequent generative model training process.

Referring to FIG. 9, the process of training and inference of an image generation model includes a generative model training process 935. In the generative model training process 935, based on the encrypted data, the system trains the LDM's denoising module ϵ_{θ}(.) Using the objective function of Equation (1), where zₜ is the noised version of

$$z = {ℰ}_{L} ( {X}_{{W}_{j}} ) = {ℰ}_{L} ( 𝒯 ( X ; {W}_{j} ) ) . \qquad ( 5 )$$

For example, the input latent codes zₜ are generated using the encrypted images X_{W}_{ⱼ} for j∈0, 1, 2, . . . , N.

According to embodiments of the present disclosure, using LDM loss alone may not make the system successfully learn the connection between the conceptual content and the associated watermark. Embodiments of the present disclosure provide an auxiliary supervision to LDM's training:

$${L}_{BCE} ( {s}_{j} , \hat{s} ) = - \frac{1}{b} {\sum }_{i = 1}^{b} [ {p}_{ji} log ( {\hat{p}}_{i} ) + ( 1 - {p}_{ji} ) log ( 1 - {\hat{p}}_{i} ) ] , \qquad ( 6 )$$

where L_{BCE}(.) is the binary cross-entropy (BCE) between the actual bit-sequence sⱼ associated with watermark Wⱼ and the predicted bit-sequence ŝ. The ŝ is computed from the denoised latent code \hat{z} as the following:

$$\hat{s} = {D}_{S} ( {D}_{L} ( \hat{z} ) ) . \qquad ( 7 )$$

According to embodiments of the present disclosure, by employing BCE, the image generation model is guided to minimize the difference between the predicted watermark and the embedded watermark. This process accordingly increases the image generation model's ability to recognize and associate watermarks with respective concepts. This process may minimize the loss function Lₐₜₜᵣ=L_{LDM}+αL_{BCE} during training, where a can be set to, for example, 2.

Referring to FIG. 9, the generative model training process 935 takes the encrypted training images X_{W} (930 in FIG. 9) and learns to generate new images that retain the embedded watermarks. This process involves feeding these images into a diffusion model or another type of generative model. The image generation model generates a latent code z (940 in FIG. 9), representing the watermarked images. This latent code z captures the essential features and watermark patterns of the input images in a compressed form. The latent code z may be an intermediary in the model training process. For example, the latent code z may be a condensed representation of the input images and embedded watermarks, encapsulating the information in the input images and embedded watermarks. The latent code z may be used to generate new images that reflect the input concepts and carry the same watermarks.

Next, the latent code is recovered, and the recovered latent code \hat{z} (945 in FIG. 9) is generated. The recovered latent code \hat{z} may be used to regenerate images that are compared with the original encrypted training images. This comparison enables the image generation model to accurately retain and reproduce the watermark information when generating new images. The image generation model generates the recovered encrypted images X_{R} (950 in FIG. 9).

During the generative model training process 935, latent code encoder E_{L}, latent code decoder D_{L}, and secret decoder Dₛ are fixed. The image generation model includes a latent diffusion model, and the latent diffusion model is trainable. For example, the latent diffusion model takes as input the latent code z and generates recovered latent code \hat{z}. For example, the latent diffusion model is trained based on a LDM loss.

A process of inference 955 is illustrated and included in FIG. 9. After the LDM learns to associate the watermarks with concepts, random Gaussian noise is used to sample the newly generated images from the model. During inference, the image generation model creates new images and embeds a watermark within the new images. For example, the generation of new images and the embedding of watermarks may occur in an integrated step.

During inference, a watermark maps to a distinctive orthogonal bit-sequence associated with a training concept. The training concept may be specific and serve as a covert signature for attribution. To attribute the generated images and identify the respective training concepts that influenced the generated images, the system predicts the secret embedded by the LDM in the generated images. For example, Equation (7) is used to make this prediction. Given a predicted binary bit-sequence, ŝ={\hat{p}₁, \hat{p}₂, . . . , \hat{p}_{b}} and the input bit-sequences sⱼ for j∈0, 1, 2, . . . , N, the attribution function f in Equation (3) is formulated as:

$$f ( \hat{s} , {s}_{j} ) = {\sum }_{i = 1}^{b} [ {\hat{p}}_{k} = {p}_{jk} ] , \qquad ( 8 )$$

where [\hat{p}ₖ=pⱼₖ] acts as an indicator function, returning 1 if the condition is true, for example, returning 1 when the bits are identical, and 0 otherwise.

A bit-sequence refers to a series of bits, such as binary bits, arranged in order. A bit in the bit-sequence represents a binary value, such as 0 or 1. For example, a bit-sequence s₁ may be 100110 . . . , and another bit-sequence s_{N} may be 111100 . . . , where the length of the bit-sequence can be dependent on the application, data type being encoded, or other factors. The predicted bit-sequence is assigned to the concept whose bit sequence it most closely mirrors. For example, the concept j* for which f(ŝ, sⱼ) is maximized:

$$j *= arg {max}_{j ∈ \{ 1 , 2 , … , N \}} f ( \hat{s} , {s}_{j} ) . \qquad ( 9 )$$

For example, the concept whose watermark is most closely aligned with the generated image's watermark is deemed to be the influencing source behind the generated image.

Referring to FIG. 9, during inference 955, the trained image generation model is used to generate new images. Gaussian noise 960 is input into the trained image generation model. Inference 955 involves taking a random noise vector and generate output images 965. Gaussian noise 960 provides the randomness to the image generation model to produce diverse and unique output images. The output images are accordingly not merely replicas of the training images but new synthesized creations that reflect the learned concepts and watermarks.

Output images 965 visually represent the input concepts and include the embedded watermarks from the corresponding training concepts. The watermarks in the output images 965 enable causal attribution of the generated images back to specific concepts or elements in the training data.

According to embodiments of the present disclosure, multiple watermarks may be used for multi-concept attribution within one single image. Some methods may attribute multiple images to one single concept. However, in real-world scenarios, one single image may encapsulate multiple concepts. Embodiments of the present disclosure provides a method involving embedding multiple watermarks into a single image for multi-concept attribution. For example, two watermarks may be added to one single image. For example, the image may be divided into two halves and resized so that each of two watermarks fits the respective halves. Each half of the image thus carries a distinct watermark information pertaining to a specific concept.

In this example, X∈ [symbol] ^{h×w×3} is the input RGB image, and Wᵢ, Wⱼ are the watermarks for two secrets sᵢ and sⱼ, a transformation [symbol] is formulated as:

$$\begin{matrix}𝒯 ( X ; {W}_{i} , {W}_{j} ) & = \{ {X}_{left} , {X}_{right} \} \\ & = \{ ( X ( : , 0 : \frac{w}{2} , : ) + R ( {W}_{i} , h , \frac{w}{2} ) ) , ( X ( : , \frac{w}{2} : w , : ) + R ( {W}_{j} , h , \frac{w}{2} ) \} ,\end{matrix} \qquad ( 9 )$$

where R is the resize function and {.} is the horizontal concatenation. The loss function is based on the two predicted secrets (sᵢ, ŝ₁) from the two halves of the generated image. The loss function is defined as:

$${L}_{attr} = {L}_{LDM} + α ( {L}_{BCE} ( {s}_{i} , {\hat{s}}_{1} ) + {L}_{BCE} ( {s}_{j} , {\hat{s}}_{2} ) ) . \qquad ( 10 )$$

FIG. 10 shows an example of a method 1000 for training a machine learning model according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1005, the system creates a training set including a set of images having a set of watermarks corresponding to a set of training concepts, respectively. In some cases, the operations of this step refer to, or may be performed by, a training component as described with reference to FIG. 6.

For example, at operation 1005, the system generates a training set that includes a variety of images, each corresponding to a specific concept, such as “magpie.” These images are prepared for watermark embedding. A watermark that uniquely represents the concept of “magpie” is integrated into relevant images. For example, operation 1005 includes selecting images that depict magpies in different contexts and make each of these images marked with the watermark. For example, this watermarking process in operation 1005 is used for the system to identify these images as related to the “magpie” concept, setting the stage for the model to learn to recognize and generate images featuring similar characteristics.

At operation 1010, the system selects a set of secrets. In some cases, the operations of this step refer to, or may be performed by, a training component as described with reference to FIG. 6.

For example, at operation 1010, the system selects a set of secrets, each corresponding to the concept “magpie”. For example, these secrets are unique bit-sequences that are used for generating the corresponding watermarks. For example, for the magpie concept, selecting a set of secrets is performed by selecting a plurality of distinct bit-sequences. The selected plurality of distinct bit-sequences may be used to encode the watermark uniquely identifying images related to magpies. For example, the selection process may involve a user, a machine, or a combination of both user and machine input.

At operation 1015, the system generates the set of watermarks based on the set of secrets, respectively. In some cases, the operations of this step refer to, or may be performed by, a training component as described with reference to FIG. 6.

For example, at operation 1015, the system generates watermarks from the selected secrets. For the magpie concept, the secret bit-sequence is transformed into a watermark. This watermark is to be embedded into images of magpies, making these images associated with this particular concept. For example, the generation of this watermark may involve using various techniques, for example, cryptographic or encoding techniques, which transform the bit-sequence into a pattern or signal, which can be embedded in the image data.

At operation 1020, the system trains an image generation model to generate images including the set of watermarks using the training set. In some cases, the operations of this step refer to, or may be performed by, a training component as described with reference to FIG. 6.

For example, at operation 1020, the system trains the image generation model using the training set. The training set includes images embedded with concept-specific watermarks. For example, the system trains the model with images that contain the watermark for the “magpie” concept. For example, the training process involves the latent diffusion model learning to generate new images that depict the concept accurately (such as magpies in various settings) and retain the embedded watermark. For example, the model is trained for accurately representing both the visual content of the magpies and the watermark information, facilitating accurate concept attribution and watermark recovery in the output image.

FIG. 11 shows an example of a computing device 1100 according to aspects of the present disclosure. The computing device 1100 is an example of, or includes aspects of, the corresponding element described with reference to FIGS. 1-4, and 6-9. The computing device 1100 includes processor(s) 1105, memory subsystem 1110, communication interface 1115, I/O interface 1120, user interface component(s) 1125, and channel 1130.

According to aspects, computing device 1100 includes one or more processors 1105. For example, one or more processors 1105 can execute instructions stored in memory subsystem 1110 to obtain an input prompt describing an image element; and generate an output image depicting the image element and a watermark. Processor(s) 1105 are an example of, or includes aspects of, the processor unit as described with reference to FIG. 6. In some cases, a processor is an intelligent hardware device, (e.g., a general-purpose processing component, a digital signal processor (DSP), a central processing unit (CPU), a graphics processing unit (GPU), a microcontroller, an application-specific integrated circuit (ASIC), a field programmable gate array (FPGA), a programmable logic device, a discrete gate or transistor logic component, a discrete hardware component, or a combination thereof.

In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special-purpose components for modem processing, baseband processing, digital signal processing, or transmission processing.

According to aspects, memory subsystem 1110 includes one or more memory devices. Memory subsystem 1110 is an example of, or includes aspects of, the memory unit as described with reference to FIG. 5. Examples of a memory device include random access memory (RAM), read-only memory (ROM), or a hard disk. Examples of memory devices include solid-state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operations such as the interaction with peripheral components or devices. In some cases, a memory controller operates memory cells. For example, the memory controller can include a row decoder, column decoder, or both. In some cases, memory cells within a memory store information in the form of a logical state.

According to aspects, communication interface 1115 operates at a boundary between communicating entities (such as computing device 1100, one or more user devices, a cloud, and one or more databases) and channel 1130 and can record and process communications. In some cases, communication interface 1115 is provided to enable a processing system coupled to a transceiver (e.g., a transmitter and/or a receiver). In some examples, the transceiver is configured to transmit (or send) and receive signals for a communications device via an antenna.

According to aspects, I/O interface 1120 is controlled by an I/O controller to manage input and output signals for computing device 1100. In some cases, I/O interface 1120 manages peripherals not integrated into computing device 1100. In some cases, I/O interface 1120 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1120 or via hardware components controlled by the I/O controller.

According to aspects, user interface component 1125 enables a user to interact with computing device 1100. In some cases, user interface component 1125 includes an audio device, such as an external speaker system, an external display device such as a display screen, an input device (e.g., a remote-control device interfaced with a user interface directly or through the I/O controller), or a combination thereof. In some cases, user interface component 1125 includes a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input prompt describing an image element;
generating, using an image generation model, an output image depicting the image element and including a watermark, wherein the image generation model is trained using a training image including the image element and the watermark; and
identifying the training image as a source of the output image based on the watermark.

2. The method of claim 1, wherein generating the output image comprises:
generating, using a generator of the image generation model, a latent code representing the input prompt and the watermark; and
decoding, using a decoder of the image generation model, the latent code to obtain the output image.

3. The method of claim 2, wherein generating the latent code comprises:
performing a latent diffusion process.

4. The method of claim 2, wherein:
the decoder is fixed during a training stage in which the generator is trained using the training image.

5. The method of claim 1, further comprising:
determining that the output image is attributable to the training image from a plurality of images in a training set.

6. The method of claim 1, wherein:
the watermark is located in a pre-determined region of the output image, wherein each of a plurality of watermarks corresponds to a plurality of pre-determined regions, respectively.

7. The method of claim 6, wherein:
the plurality of pre-determined regions are non-overlapping.

8. The method of claim 1, further comprising:
obtaining a noise input, wherein the output image is generated based on the noise input.

9. A method for training a machine learning model, comprising:
creating a training set by adding a watermark to an image depicting an image element; and
training, using the training set, an image generation model to generate an output image depicting the image element and including the watermark based on an input prompt describing the image element.

10. The method of claim 9, wherein creating the training set comprises:
adding a plurality of watermarks to a plurality of images, respectively, wherein the plurality of watermarks are added at a plurality of pre-determined regions, respectively.

11. The method of claim 9, wherein creating the training set comprises:
selecting a plurality of secrets; and
generating a plurality of watermarks based on the plurality of secrets, respectively.

12. The method of claim 9, wherein creating the image generation model comprises:
computing a latent diffusion loss; and
updating parameters of the image generation model based on the latent diffusion loss.

13. The method of claim 9, wherein creating the image generation model comprises:
computing an encryption loss; and
updating parameters of the image generation model based on the encryption loss.

14. The method of claim 9, wherein:
a decoder of the image generation model is fixed during the training.

15. The method of claim 9, wherein:
a generator of the image generation model is pre-trained prior to training.

16. An apparatus comprising:
at least one processor;
at least one memory storing instruction executable by the at least one processor; and
an image generation model comprising parameters stored in the at least one memory and trained generate an output image depicting an image element and including a watermark, wherein the image generation model is trained using a training image including the image element and the watermark, and identify the training image as a source of the output image based on the watermark.

17. The apparatus of claim 16, wherein:
the image generation model comprises a generator including a latent diffusion model.

18. The apparatus of claim 16, wherein:
the image generation model comprises a decoder that is fixed during the training.

19. The apparatus of claim 16, further comprising:
an attribution component configured to determine that the output image is attributable to the training image from a plurality of images in a training set.

20. The apparatus of claim 16, further comprising:
a training component configured to perform the training.
